(19) United States
(12) Patent Application Publication
(10) Pub. No.: US 2007/0278257 A1
(43) Pub. Date: Dec. 6, 2007

(54) Collapsing dispensing spout

(76) Inventors: Keith E. Antal SR., Valatie, NY (US); Chad E. Lagace, Cohoes, NY (US); Lawrence E. Renck, Hartsville, SC (US); James E. Johanson, Old Chatham, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/808,274

(22) Filed: Jun. 5, 2007

Related U.S. Application Data
(60) Provisional application No. 60/811,575, filed on Jun. 6, 2006.

(51) Int. Cl. B67D 3/00

(52) U.S. Cl. 222/535; 222/531

(57) ABSTRACT

A spout for containers of pourable materials is provided having side panels that are flexibly secured to a central panel and positioned on a cap surface, adjacent a pour opening. The side panels are structured to extend outwardly from the central panel when the spout is in its closed position and to lie substantially parallel to the end cap. The side walls are flexibly secured to the central portion of the spout to permit the spout to move inwardly along the pour opening to define a projecting spout extending from the end cap.

### CROSS-REFERENCE TO RELATED APPLICATION

This application claims priority to U.S. provisional application No. 60/811,575, filed Jun. 6, 2006, the entire contents of which are incorporated by reference.

### FIELD OF THE INVENTION

The present invention relates to dispensing spouts for containers. More specifically, the invention provides a collapsible dispensing spout.

### BACKGROUND

Consumer products are sometimes offered in packages or containers that include a dispensing spout. Such products include powdered or granular materials, for example, food seasonings (salt, pepper, sugar, cinnamon, spices), household cleaners (carpet cleaners, floor cleaners), household care chemicals (fertilizer, ice-melting substances, salt), particulate materials used in the building industry (cement, stone dust, sand) or in a manufacturing industry (concentrates in plastic, colorants in wax), and other similar materials. Spouts are also commonly utilized with liquid products, for example, various food additives, laundry detergents, or other household products. Many known spouts are designed to move from an open position wherein the spout guides the flow of product as it dispensed, to a closed position wherein the spout closes the dispensing opening.

When a dispensing spout is in its closed position, the side walls of the spout protrude into the container. The spout may interfere with the assembly or attachment of the end cap on the container, thereby increasing the amount of space taken up within the container, potentially increasing the cost of shipment. Additionally, the spout may interfere with a tamper evident seal that is positioned on the container.

### SUMMARY OF THE INVENTION

One embodiment of the present invention includes an end cap having a cap surface defining an opening. A spout is hingedly secured to the cap surface adjacent one side of the opening. The spout moves between a closed position wherein the spout closes the opening and an open position wherein the spout extends outward from the opening. The spout includes at least one central panel and two side panels hingedly secured to the side edges of the central panel. The central panel forms the bottom, central portion of the spout, and the side panels form the side walls of the spout. The side panels are structured to flex inward toward the central panel when the spout is in its open, operative position and flex outward to lie substantially parallel to the central panel and the surface of the end cap when the spout is in its closed position. A tamper evident seal is disposed adjacent the end cap and below the cap surface. Because the side walls flex outward when the spout is pushed into the container, the tamper evident seal may be placed relatively close to the end cap without damage being caused to the tamper evident seal by the side walls.

In another aspect of the invention, the side panels of the spout portion may comprise one or more additional panels which are disposed on opposite sides of the central panel. The outer most panel portion of the side panel defining an edge adjacent the cap surface. The edge is hingedly secured to the cap surface of the end cap, with additional hinges connecting the adjacent panels and connecting the side panel to the central panel. The plurality of hinges permit the flexing of the side panels so that the spout collapses upon moving from the open position to the closed position. When moved into the closed position, with the side panels substantially parallel to the cap surface, the central panel forms a seal over the pouring opening within the end cap.

In a further aspect of the invention, the spout portion may include an over-center snap position. The snap position is formed by the interaction of the central panel, the side panels, the top surface and the hinges disposed therebetween. The hinges permit the spout to collapse into a position substantially parallel to the cap surface when in the closed position and to open so as to define the spout when moved to the open position. The over-center snap position is defined between the open position and the closed position, whereby the spout is resiliently biased away from the open position upon moving past the over-center snap position.

In an additional aspect of the invention, the spout may include a lip portion adjacent the pour opening, whereby the central panel may be inserted under the lip portion so as to secure the collapsed spout in the closed position prior to ready access. Alternatively, an adhesive may be incorporated into the spout surface which interacts with the cap surface to secure the spout in the closed position.

These and other features and advantages of the invention will become more apparent through the following description and drawings.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a top perspective view of an end cap according to the present invention showing a spout formed as part of the end cap surface.

FIG. 2 is a top plan view of the end cap of FIG. 1 showing the manner in which the side panels of the spout are flexed inward.

FIG. 3 is a perspective view of the end cap according to the present embodiment showing the spout being inserted into the opening defined in the end cap.

FIG. 4 is a bottom perspective view of the end cap of the present embodiment showing the spout moving into the closed position.

FIG. 5 is a bottom perspective view of an end cap of the present embodiment showing the spout in the closed position with the side panels extended substantially parallel to the cap surface.

FIG. 6 is a partially exploded bottom perspective view of the end cap of the present embodiment along with a tamper-evident seal.

FIG. 7 is a bottom perspective view of an end cap of the present embodiment having the tamper-evident seal attached adjacent the end cap.

FIG. 8 is a top perspective view of the end cap of the present embodiment showing the spout partially opened.

FIG. 9 is a side perspective view of the end cap of the present embodiment showing the spout in its open position.

FIG. 10 is a top perspective view of another embodiment of an end cap according to the present invention showing the spout in its open position.

FIG. 11 is a top perspective view of the end cap of FIG. 10 showing the spout in its closed position.

FIG. 12 is a top isometric view of an alternative embodiment of an end cap according to the present invention showing the spout position in its closed position.

FIG. 13 is a top isometric view of the end cap of the present embodiment showing the spout partially opened.

FIG. 14 is a top plan view of the end cap of the present embodiment showing the spout fully opened.

FIG. 15 is a side elevational view of the end cap of the present embodiment showing the spout fully opened.

### DETAILED DESCRIPTION

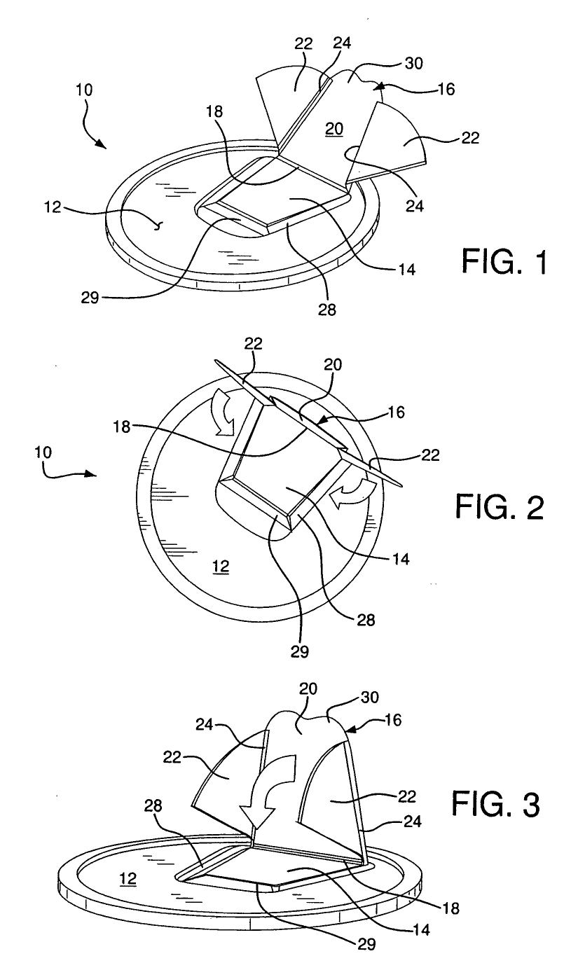

In the drawings, where like reference numerals designate like elements, there is shown various views of an end cap having a spout formed thereon. Referring to FIGS. 1-9, there is shown a first embodiment of an end cap, which is generally designated by the numeral 10. The end cap 10 includes a cap surface 12 defining a pour opening 14 therein. A spout 16 is connected to one side of the pour opening 14 by the hinge 18, which in the illustrated example is a living hinge. The spout 16 includes a central panel 20 and two side panels 22, disposed on opposing sides of the central panel 20. In the illustrated example, each side panel 22 is connected to the central panel 20 by a hinge 24, which in the illustrated example is also a living hinge. As illustrated, the end cap and spout are integrally formed.

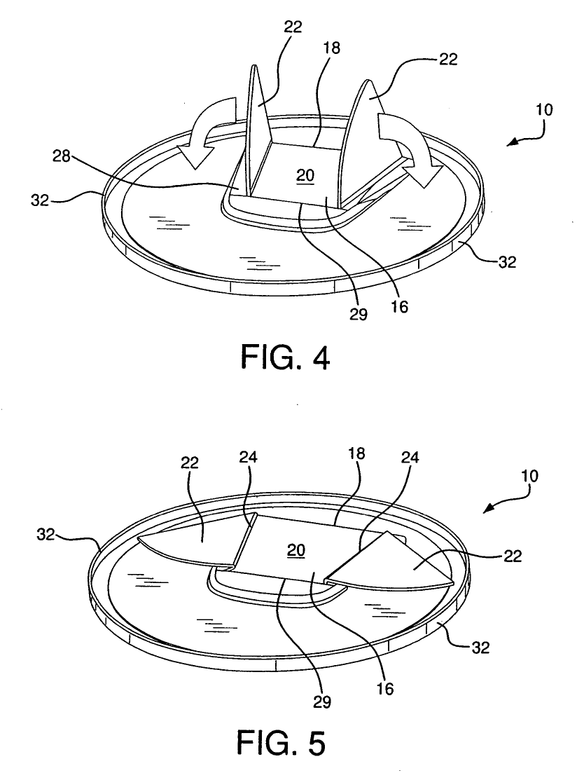

The end cap 10 includes a depression 28 extending around three sides of the pour opening 14, and a lip 29 extending upward from the depression 28. The depression 28 receives the spout central portion 20, which engages the lip 29, to form a closure of the pour opening 14 when the spout 16 is in its downward or closed position. The depression 28 is structured to extend beyond a finger-grasping portion 30 on the end of the central panel 20 when a spout 16 is closed. The illustrated end cap 10 includes a peripheral lip 32 (FIGS. 4 and 5) to facilitate securing the end cap 10 to a dispenser.

Referring to FIGS. 2 and 3, the side panels 22 are folded inward at the hinges 24, positioning the side panels 22 inside the edges of the opening 14. The spout 16 is then closed so that the side panels 22 move below the cap surface 12. Referring to FIGS. 4 and 5, because the side panels 22 are molded in an extended position, once the spout 16 is closed, the side panels 22 are biased by the manner in which they are molded towards a position wherein they are substantially parallel to the top surface 12 (FIG. 5). The side edge portions 24 of the central panel 20 extend a sufficient distance through the opening 14 so that, with the central panel 20 above the bottom of the cap surface 12, the side panels 22 are positioned below the cap surface 12.

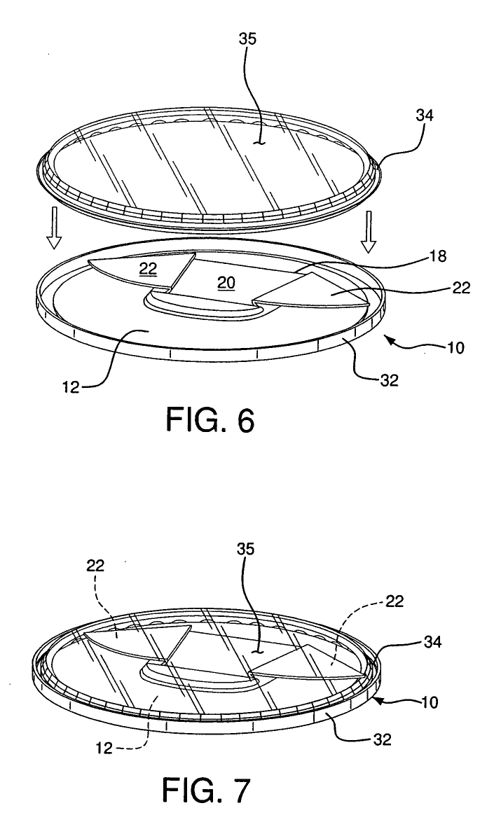

Referring to FIGS. 6 and 7, a ring 34 is shown, which forms the support frame for a tamper-evident seal 35. As shown, the ring 34 and seal 35 combination are assembled with the end cap 10. With the side panels 22 substantially parallel to the top surface 12, the seal 35 is positioned closely adjacent to the bottom of the cap surface 12. The lip 32 received the ring 34 and forms a groove, which is fit over the rim of a container. The positioning of the side panels 22 adjacent the cap surface 12 resists interference with and damage to a tamper-evident seal 32 by avoiding the downward protrusion of the side panels 22 into the seal surface.

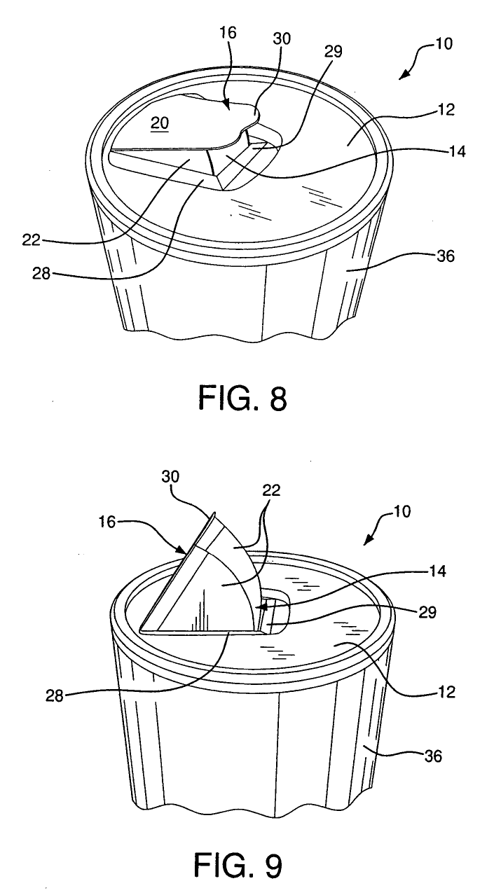

As shown in FIGS. 8 and 9, the end cap 10 and ring 34 may be secured to the top rim of a container 36, for example, by using an adhesive. A consumer purchasing a dispenser may remove the end cap 10 from the container 36, remove the tamper-evident seal 35, and reinstall the end cap 10. When dispensing is desired, the user inserts a finger under the finger-grasping portion 30 and into the depression 28. Pushing up on portion 30, the spout 16 is raised from the position in FIG. 8 to the position of FIG. 9. Once the spout 16 is in the raised position, product may be dispensed from the container 36 through the pour opening 14. The spout 16 may then be closed thereby closing the opening 14. Once the dispenser 36 has been purchased by a consumer, and the tamper-evident seal removed, it is no longer critical for the side panels 22 to remain substantially parallel to the top surface 12 when the spout 16 is closed.

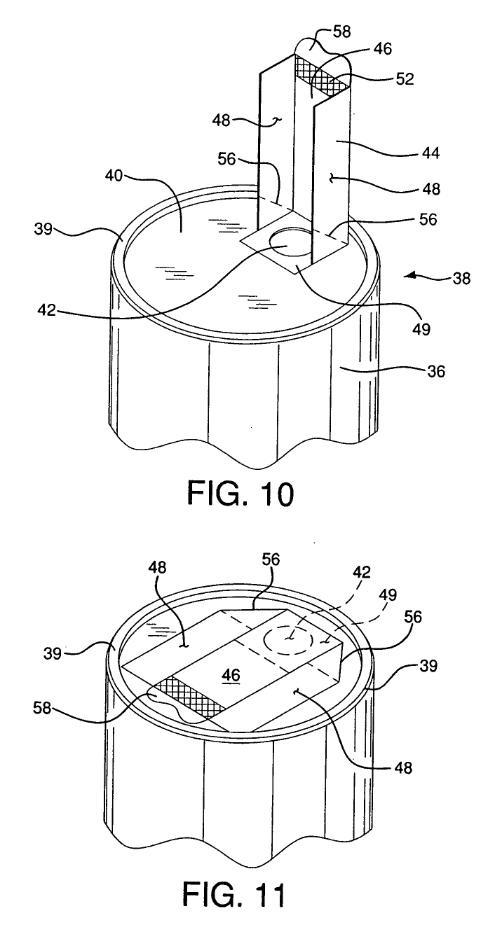

Referring to FIGS. 10 and 11, there is shown another embodiment of the end cap 38 attached to a container 36. The end cap 38 includes a cap surface 40 having a peripheral lip 39 that is substantially the same as the lip 32 of end cap 10. A pour opening 42 is defined within the top surface 40. A spout 44 is flexibly secured adjacent the pour opening 42. The spout 44 includes a central panel 46 and a pair of side panels 48 disposed on opposing sides of the central panel 46. The side panels 48 are flexibly secured along one edge to the central panel 46, and are secured to the cap surface 40, adjacent to the opening 42, by a base member 49.

Side panels 48 may be made from a flexible material, for example, tape, foil, flexible plastic, cloth, or laminates of such materials. Alternatively, side panels 48 may be made from a rigid or semi-rigid material, for example, paperboard, metal or plastic, having a score line or living hinge therein to permit the side panels 48 to bend with respect to the central panel 46 and the base 49.

When the spout 44 is in its open position, it extends outward from the cap surface 40, thereby directing a flow of material from the opening 42 to a desired location. To close the spout 44, it is folded downward from the position of FIG. 10 to the position of FIG. 11, so that the central panel 46 and each of the side panels 48 lie substantially flat against the cap surface 40. Each of the side panels 48 define a fold or score line 56, permitting the panels to flex outward and to lie flat against the cap surface 40. An adhesive 52 is applied to the spout 44 to secure the central panel 46 against the top surface 40, closing the opening 42. As illustrated in FIG. 11, a seal is formed over the opening 42, and the adhesive 52 adheres the central panel 46 to cap 38, with the central panel 46 covering the opening 42. A lift tab 58 may be provided at the free end of the central panel 46 to facilitate moving the spout 44 from the closed position to the open position.

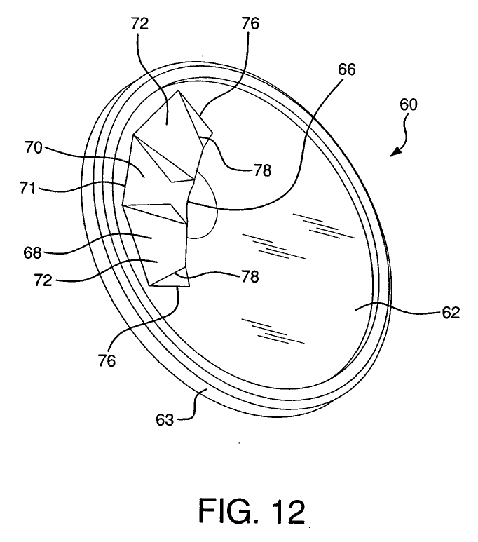

In FIGS. 12-15, there is illustrated yet another embodiment of an end cap 60 and spout 68 combination. The end cap 60 includes a cap surface 62 having a peripheral lip 63 similar to the lip 32 of the end cap 10. A pour opening 64 is defined within the cap surface 62. A lip 66 is defined adjacent to the opening 64. The spout 68 extends upward from the top surface 62, adjacent the opening 64. The spout 68 includes a central panel 70 hingedly secured to the top surface 62 at hinge 71. A plurality of side panels 72, 74 are disposed on either side of the central panel 70. Each of the side panels 74 includes an edge 76 that is hingedly connected to the top surface 62. Each of the panels 72 includes hinge connections 78 between itself and an adjacent side panel 74 or central panel 70. The side panels 72 and 74 alternate, with two side panels 74 and two side panels 72 disposed on either side of the central panel 70. The panels 72, 74 may fold on top of the other of one another. For example, as shown in FIG. 12, panel 72 is disposed on top of an adjacent panel 74 when the spout 68 is closed.

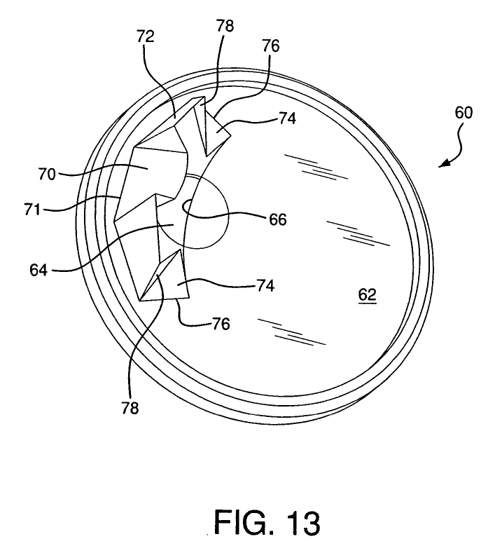

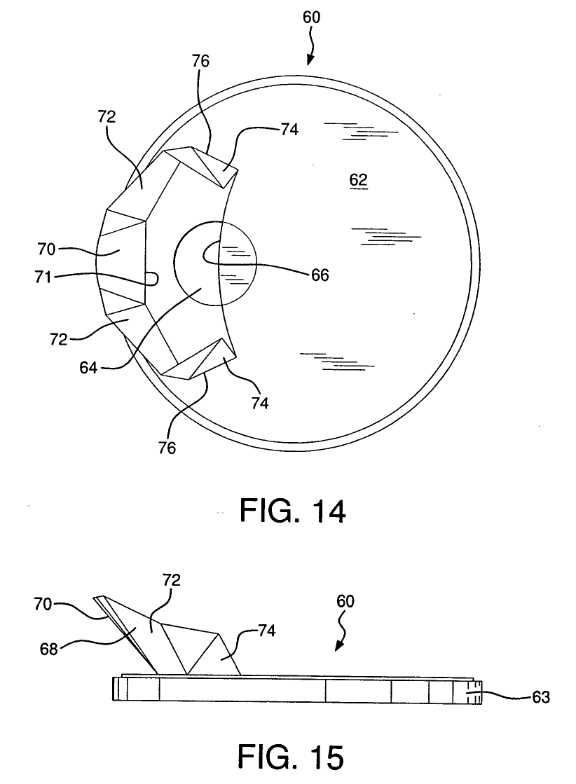

With the spout 68 in the closed position of FIG. 12, the hinges 71, 76 and 78 are bent so that the central panel 70 and side panels 72, 74 are positioned over the opening 64 and flush with the cap surface 62. The spout 68 may be moved from the closed position to the open position of FIGS. 13-15 by extending a finger under the lip 66 to release the spout 68. The spout 68 is pulled through to the open position of FIGS. 14 and 15. Product may then be dispensed by tilting the container to which the end cap 60 is secured. The spout 68 may be closed by pushing the central panel 70 and side panels 72, 74, back towards their closed position.

The spout 68 is biased towards both its open position and its closed position by the interaction of the panels 70, 72, 74 and the hinges 71, 76, 78. These components are structured to define a snap-over point somewhere between the closed position of FIG. 12 and open position of FIGS. 14 and 15. When opening or closing the spout 68, the user will encounter increasing resistance until the spout 68 reaches the snap-over point, at which point it will be biased towards the desired position.

The present invention therefore provides an end cap for a dispenser having a spout that does not extend substantially downward below the end cap when the spout is closed, at least during the initial assembly and shipment of the dispenser. The spout therefore resists interference with and resulting damage to a tamper-evident seal disposed below the end cap.

While a specific embodiment of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

What is claimed is:

1. An end cap for a container comprising:
a cap surface defining an opening therein;
a lip portion, surrounding the cap surface and adapted to engage a rim on the open end of a container; and
a spout secured at one side edge of the opening, the spout being movable between a closed position wherein the spout closes the opening and an open position wherein the spout extends outward from the opening, the spout comprising
a central panel having a pair of side edges, and
at least one side panel flexibly secured to each of the side edges of the central panel, each of the side panels structured to extend outward from the central panel when the spout is in its closed position, and to engage the side edges of the opening and move inwardly to define the spout when the spout is in its open position.

2. The end cap according to claim 1, wherein the side panels are hingedly secured to the central panel and detached from the cap surface, the side panels being held substantially perpendicular to the cap surface when the spout is in an open position.

3. The end cap according to claim 1, wherein the side panels comprise a plurality of side panels disposed on opposing sides of the central panel, the outer most side panels from the central panel defining an edge adjacent to the cap surface that is connected to the cap surface.

4. The end cap according to claim 3, wherein the central panel and side panels define and over-center snap position between the open position and the closed position, whereby the spout is biased away from the closed position upon moving past the over-center snap position.

5. The end cap according to claim 4, wherein the over-center snap position is formed by interaction of the central panel, side panels, cap surface and hinges disposed therebetween.

6. The end cap according to claim 1, wherein the side panels are made of a flexible material and are secured along one edge to the central panel and along another edge to the top surface adjacent to the opening, and wherein moving the spout to the closed position causes the side panels to fold adjacent the central panel and to lie substantially parallel to the cap surface.

7. The end cap according to claim 6, wherein the side panels are made from a material selected from the group consisting of tape, foil, flexible plastic and cloth.

8. A container comprising:
a storage chamber defined by a bottom wall and at least one side wall;
a top opening defined by the side wall, opposite of the bottom wall; and
an end cap secured over the top opening, the end cap comprising
a cap surface defining a pour opening therein, and
a spout hingedly secured to the cap surface at one side of the pour opening, the spout moveable between a closed position wherein the spout closes the pour opening and an open position wherein the spout extends outward from the pour opening, the spout comprising
a central panel, and
a side panel hingedly secured to the side edges of the central panel, each side panel extending outward from the central panel and lying substantially parallel to the cap surface when the spout is in the closed position.

9. The container according to claim 8, further comprising a tamper evident seal secured over the top opening and disposed below the end cap, whereby the side panels lie substantially parallel to the cap surface and the seal when the spout is in the closed position.

10. The container according to claim 8, wherein the side panels are detached from the top surface and are structured to fit within the pour opening, whereby the side panels are held in a position substantially perpendicular to the cap surface when the spout is in an open position, and the side panels are disposed below the cap surface when the spout is in a closed position.

11. The container according to claim 8, wherein the side panels comprise a plurality of panels disposed on opposing sides of the central panel, the panels that define an edge adjacent to the cap surface hingedly connected to the cap surface along an outer edge.

12. The container according to claim 11, wherein the central panel and side panels define and over-center snap position between the open position and the closed position, whereby the spout is biased away from the cap surface when moved past the over-center snap position.

13. The container according to claim 12, wherein the over-center snap position is formed by interaction of the central panel, side panels, cap surface and hinges disposed therebetween.

14. The container according to claim 8, wherein the side panels are made of a flexible material and are secured along one edge to the central panel and along another edge to the cap surface adjacent to the pour opening, whereby closing the spout causes the side panels to lie substantially parallel to the cap surface, and the pour opening the spout causes the side panels to extend inward from the cap surface and the central panel.

15. The container according to claim 14, wherein the side panels are made from a material selected from the group consisting of tape, foil, flexible plastic and cloth.
